(19) United States
(12) Patent Application Publication
(10) Pub. No.: US 2016/0100709 A1
(43) Pub. Date: Apr. 14, 2016

(54) BACKROOM BLENDING SYSTEM

(71) Applicant: The Coca-Cola Company, Atlanta, GA (US)

(72) Inventors: Arthur G. Rudick, Atlanta, GA (US); Gregg Allen Carpenter, Marietta, GA (US)

(21) Appl. No.: 14/882,514

(22) Filed: Oct. 14, 2015

Related U.S. Application Data
(60) Provisional application No. 62/063,669, filed on Oct. 14, 2014.

(51) Int. Cl. A47J 31/40; B67D 1/10; B01F 15/02; B67D 1/00

(52) U.S. Cl. CPC A47J 31/402; B67D 1/0043; B67D 1/10; B01F 15/0243; B01F 15/0216; B01F 15/026

(57) ABSTRACT

A dispenser for brand specific beverage bases may include a sweetener source pressurized by a carbon dioxide inlet and a blending module configured to receive the sweetener from the sweetener source. The blending module may include more than one micro-ingredient sources and a batch tank, where the micro-ingredient sources are in communication with a batch tank. The blending module may also be in communication with at least one dispensing nozzle. Finally, a diluent inlet may also be in fluid communication with the blending module.

### CROSS REFERENCE TO RELATED APPLICATION

This application claims the benefit of priority from U.S. Provisional Application No. 62/063,669, filed Oct. 14, 2014, which is incorporated herein by reference in its entirety.

### BACKGROUND

Blending systems typically provide beverage options to individual rooms, by combining micro-ingredients with various types of macro-ingredients, such as sweeteners, with diluents to form a beverage base. Traditionally, beverage bases may be stored in a bulk storage tank for dispensing. Bulk storage tanks for specific beverage bases may traditionally receive syrups and/or other types of concentrates mixed with a diluent. The syrups or other types of concentrates may include a mixture of a sweetener, such as high fructose corn syrup (“HFCS”), sucrose (sugar), or other types of materials, with flavorings, colors, or other ingredients.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Pumping and metering multiple brand specific beverage bases to a system is disclosed. An embodiment of the dispenser may include a sweetener source pressurized by a carbon dioxide inlet and a blending module configured to receive the sweetener from the sweetener source. The blending module may include more than one micro-ingredient sources and a batch tank, where the micro-ingredient sources are in communication with a batch tank. The blending module may also be in communication with at least one dispensing nozzle. Finally, a diluent inlet may also be in fluid communication with the blending module. In an alternative embodiment, there may be more than one batch tank within the system. Likewise, three-way diverter valves may be implemented to alternate the sweetener source, diluent sources, and diluent inlet to the multiple batch tanks in the system.

An alternative dispenser for pumping and metering beverage bases may include a mixing chamber in fluid communication with the sweetener source, the diluent sources, an optional storage tank, and the diluent inlet. Furthermore, a multiport valve may be employed to receive a beverage base from the mixing chamber via the storage tank to dispense to a nozzle. This may occur during a dispensing phase. Moreover, the multiport valve may be employed to flush a diluent and any residual beverage base to a drain. This may occur during a flushing phase. In an alternative embodiment, the mixing chamber may not be in direct communication with the storage tank. Rather, the multiport valve may be in fluid communication with the mixing chamber. The multiport valve may be employed to receive a beverage base from the mixing chamber to dispense to a plurality of storage tanks. Each storage tank may have an associated nozzle. This may occur during a dispensing phase. Moreover, the multiport valve may be employed to flush a diluent and any residual blended beverage base to a drain. This may occur during a flushing phase. The flushing phase in this embodiment only flushes the mixing chamber, whereas in the previous embodiment, the mixing chamber and the storage tank may be flushed.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a schematic view of a dispenser for multi-room operation as is described herein;

FIG. 2 is a schematic view of an alternative dispenser for multi-room operation as is described herein;

FIG. 3 is a schematic view of an alternative dispenser for multi-room operation as is described herein; and

FIG. 4 is a schematic view of an alternative dispenser for multi-room operation as is described herein.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

It should be understood that “beverage,” as used herein, includes, but is not limited to, pulp and pulp-free citrus and non-citrus fruit juices, fruit drinks, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combination thereof. The beverage may also be carbonated or non-carbonated. The beverage may comprise beverage components (e.g., beverage bases, colorants, flavorants, and additives.)

The term “beverage base” refers to parts of the beverage or the beverage itself prior to additional colorants, additional flavorants, and/or additional additives. According to certain embodiments of the present invention, beverage bases may include, but are not limited to syrups, concentrates, and the like that may be mixed with a diluent such as still or carbonated water or other diluent to form a beverage. The beverage bases may have reconstitution ratios of about 3:1 to about 6:1 or higher but generally less than 10:1. According to certain embodiments, beverage bases may comprise a mixture of beverage base components.

The term “beverage base component” refers to components which may be included in beverage bases. According to certain embodiments of the present invention, the beverage base component may comprise parts of beverages which may be considered food items by themselves. According to certain embodiments of the present invention, the beverage base components may be micro-ingredients such as an acid portion of a beverage base, an acid-degradable and/or non-acid portion of a beverage base, natural and artificial flavors, flavor additives, natural and artificial flavors, nutritive or non-nutritive natural or artificial sweeteners, additives for controlling tartness (e.g., citric acid or potassium citrate), functional additives such as vitamins, minerals, or herbal extracts, nutraceuticals, or medicaments. The micro-ingredients may have reconstitution ratios from about 10:1, 20:1, 30:1, or higher with many having reconstitution ratios of 50:1 to 300:1. The viscosities of the micro-ingredients may range from about 1 to about 100 centipoise.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

By “separately stored” it is meant that the components of the present invention are kept separate until combined. For instance, the components may be separately stored individually in each container or may be all stored in one container wherein each component is individually packaged (e.g., plastic bags) so that they do not blend while in the container. In some embodiments, the container, itself, may be individual, adjacent to, or attached to another container.

The term “blended beverage” includes final products wherein two or more beverages have been blended or mixed or otherwise combined to form a final product.

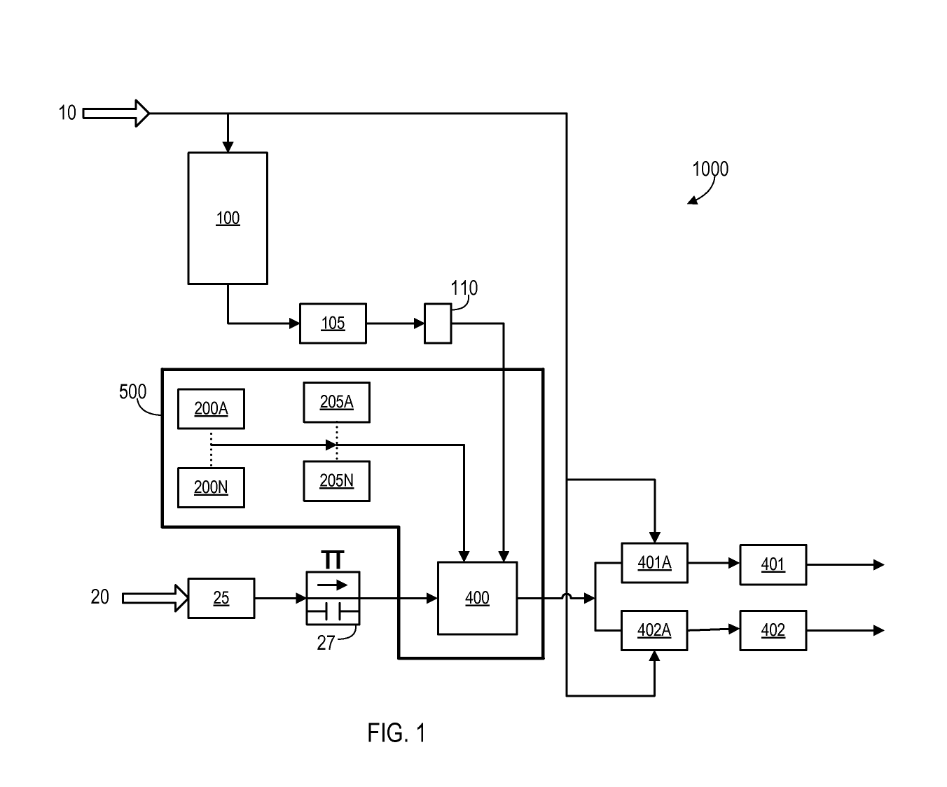

According to certain embodiments, the present invention provides for methods and apparatuses that allow for the dispensing of a variety of beverage bases. Embodiments are described in detail below and are exemplified in FIGS. 1-4. It should be understood that any of the features in embodiments of the methods and apparatuses of the present invention described may be used in combination with each other in alternate embodiments.

Referring now to the drawings, in which like numerals refer to like elements throughout the several views, FIG. 1 shows a schematic view of a dispenser 1000 for pumping and metering multiple beverage bases to a multi-room system as is described herein. As shown in FIG. 1, dispenser 1000 may comprise carbon dioxide inlet 10, one or more sweetener sources 100, micro-ingredients 200A-200N, and diluent inlet 20. The sweetener source 100 may include a concentrated sweetener solution beverage base component. For example, the sweetener source 100 may be high fructose corn syrup (HFCS), sucrose, high potency sweeteners such as inverted sugars or other types of sweeteners or sweetener blends. In some embodiments, the sweetener source 100 may have reconstitution ratios of 3:1, 5:1, 10:1, 15:1 or higher. In some embodiments, the sweetener may include HFCS. The sweetener source 100 may include a tank, a bag-in-box, a figal (five gallon), or any other type of container or containers. Furthermore, the sweetener source 100 may be metered to a batch tank 400 via a vacuum regulator 105, and via metering pump 110. In some embodiments, the dispenser 1000 may omit the sweetener source 100. Where the sweetener source 100 is omitted, or in addition to the sweetener source 100, one or more of the micro-ingredients 200A-200N may include high yield sweeteners or non-nutritive sweeteners. For example, one or more of the micro-ingredients 200A-200N may include a concentrated sweetener beverage base component such as aspartame, steviol glycosides, sucralose, and the like. In some embodiments, the micro-ingredients 200A-200N may have reconstitution ratios of 10:1, 20:1, 50:1, 100:1, 300:1, or higher.

Metering Pump 110 may include a conventional bag-in-box pump or another type of metered pumps, positive displacement pumps, including reciprocating, metering, solenoid (ulka), syringe, rotary pump, and/or another type of fluid moving device. In an example embodiment, the diluent inlet 20 may include a water inlet. Furthermore, diluent inlet 20 may originate from a municipal water supply via a filter.

One or more vacuum regulators 105 also may be used. The vacuum regulators 105 may be positioned upstream of the metering pump 110 or otherwise. The vacuum regulator 105 may be of conventional design and generally may be used with a bag-in-box source. The vacuum regulator 105 may maintain a substantially constant vacuum at the inlet thereof. Similar types of regulator devices may be used herein.

The dispenser 1000 also may include a blending module 500. The blending module 500 may include the micro-ingredients 200A-200N, and the batch tank 400. The micro-ingredients 200A-200N may include a tank, a bag-in-box, a figal (five gallon), cartridge, carton, or any other type of container or containers. Furthermore, the micro-ingredients 200A-200N may correspond to a brand specific beverage base that requires a two-part or multi-part micro-ingredient recipe. For example, a beverage brand A may have a beverage base that is composed of a first micro-ingredient and a second micro-ingredient. Therefore, micro-ingredients 200A-200N may include anywhere from one micro-ingredient source to an infinite number of micro-ingredient sources. Likewise, micro-ingredients 200A-200N may correspond to multiple brand specific beverage bases that require a one-part or multi-part micro-ingredient. Furthermore, micro-ingredients 200A-200N may be metered to the batch tank 400 via pumps 205A-205N respectively. The pumps 205A-205N may include anywhere from one pump corresponding to one micro-ingredient source to an infinite number of pumps corresponding with the infinite number of micro-ingredient sources. The pumps 205A-205N may include conventional bag-in-box pumps or other types of metered pumps, positive displacement pumps, including reciprocating, metering, solenoid (ulka), syringe, rotary pumps, and/or other types of fluid moving devices. Pumping and metering multiple brand specific beverage bases to a multi-room system may include a diluting process at the batch tank 400. The beverage base components may be diluted utilizing the diluent inlet 20.

Diluent inlet 20 may be metered to the batch tank 400 via a conventional mechanical flow controller 25 and via an on/off solenoid valve 27. In addition, the diluent inlet 20 may be metered to the batch tank 400 via other means of metering the diluent. The diluent may include noncarbonated water. The batch tank 400 may maintain atmospheric pressure. Furthermore, the batch tank 400 may have a high-low sensor to detect the level of all the mixed ingredients within the batch tank 400. When the level of ingredients drops below the low-level sensor, an electronic controller (not shown) may simultaneously open the diluent solenoid valve 27, pulse the pumps 205A-205N at a predetermined rate, and run the metering pump 110 for the sweetener source 100 at a predetermined rate. This may allow all of the ingredients to be metered to the batch tank 400 in the proper ratio to form a brand specific beverage base. When the ingredient level reaches a high-level sensor, the flow of all ingredients may be simultaneously stopped. In some embodiments, the high-level sensor may not be present. Thus, upon the beverage base dropping below the low-level sensor, a predetermined amount of each ingredient required to constitute the beverage base may be pumped to the batch tank 400 in a batch manner. Furthermore, on-demand pumps 401 A and 402B may draw ingredients from the bottom of the batch tank 400 as needed for each brand specific beverage base. When in dispense mode, the brand specific beverage base from batch tank 400 may be dispensed to the nozzles 401 and 402 via on-demand pumps 401A and 402A. On-demand pumps 401A and 402A may be pressurized using carbon dioxide inlet 10.

In some embodiments, brand specific beverage bases may have reconstitution ratios of about 5:1 or 6:1 and may be formed from a combination of any of the sweetener source 100 (e.g., HFCS or non-nutritive sweetener), the micro-ingredients 200A-200N, and diluent (e.g., water) from the diluent inlet 20. For example, a brand specific beverage base may formed in the batch tank 400 by pumping HFCS having a 5:1 reconstitution ratio, a flavored micro-ingredient having a 50:1 reconstitution ratio, an acidic micro-ingredient having a 50:1 reconstitution ratio and water to form a beverage base concentrate (e.g., a cola beverage) having a 5:1 reconstitution ratio. Upon the beverage base concentrate being delivered to the nozzles 401 and 402 (via on-demand pumps 401 A and 402A), carbonated water may be added (i.e., as an additional diluent) to produce a finished cola beverage. As another example, a brand specific beverage base may formed in the batch tank 400 by pumping non-nutritive sweetener having a 100:1 reconstitution ratio, a first flavored micro-ingredient having a 50:1 reconstitution ratio, an acidic micro-ingredient having a 50:1 reconstitution ratio, a second flavored micro-ingredient having a 50:1 reconstitution ratio, and water to form a beverage base concentrate (e.g., a diet cherry cola) having a 6:1 reconstitution ratio. Upon the beverage base concentrate being delivered to the nozzles 401 and 402 (via on-demand pumps 401 A and 402A), carbonated water may be added (i.e., as an additional diluent) to produce a finished diet cherry cola beverage. In some embodiments, beverage base concentrates may be formed that comprise still beverages (with the diluent added at the nozzles 401 and 402 being still water instead of carbonated water). In some embodiments, beverage base concentrates may also be formed using a blend of nutritive and non-nutritive sweeteners (i.e., to form low calorie finished beverages).

The blending module 500 may be located either adjacent to or remotely from the sweetener source 100. Where the sweetener source 100 is stored in a remote tank, the tank may be pressurized utilizing the carbon dioxide inlet 10. Where the sweetener source 100 is stored in a remote bag-in-box, the pressure of the carbon dioxide inlet 10 may drive the sweetener from the source 100 to the batch tank 400 via the vacuum regulator 105 and metering pump 110. If the sweetener source 100 is located adjacent to the blending module 500, the metering pump 110 may be used to draw the sweetener from source 100 and pump it to the batch tank 400. Where the sweetener source 100 is located adjacent to the blending module 500, the sweetener source 100 may not be pressurized utilizing the carbon dioxide inlet 10 and the vacuum regulator 105 may not be required. The sweetener may be metered into the batch tank 400 by an electronically controlled gear pump, located at metering pump 110.

As shown in FIG. 1, the vacuum regulator 105 may be located upstream of the gear pump 110 to ensure that the mixture of the sweetener arrives at the inlet of the gear pump 110 at a pressure appropriate for the operation of the gear pump 110. Micro-ingredients 200A-200N may require agitation in order to prevent separation of components of the micro-ingredients 200A-200N. Agitation may be applied to the micro-ingredients 200A-200N by implementing an agitation system. One example of an agitation system is a motor operated crank mechanism configured to move a container holding the micro-ingredients 200A-200N back and forth. Other examples include a motor driven mixing blade, and a pumped recirculation loop. Furthermore, where each of the micro-ingredients 200A-200N are in a bag-in-box, cartridge, or carton, it may not be desirable to agitate the bag-in-box, cartridge, or carton more than necessary. Therefore, the bag-in-box(es), cartridge(s), or carton(s) holding the micro-ingredients 200A-200N may remain stationary during idle periods, and agitation may be performed only after the low level sensor is activated, initiating the ingredient filling sequences. Furthermore, the ingredient filling sequence may be delayed until after the agitation cycle is complete. The batch tank 400 may also be agitated.

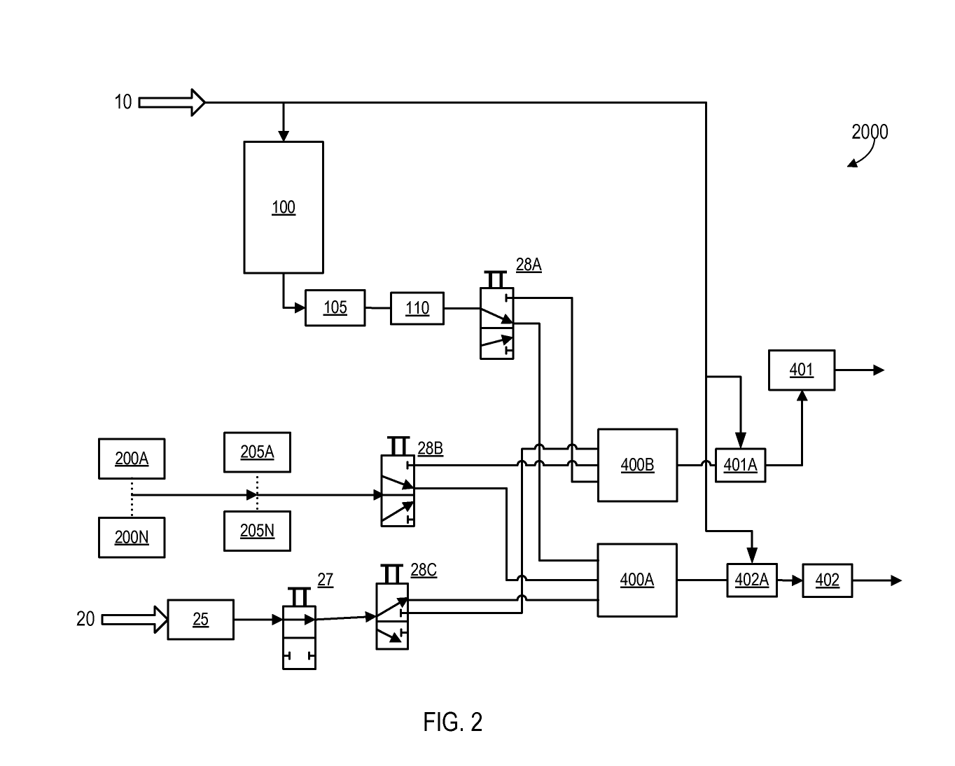

FIG. 2 shows a further embodiment of a dispenser 2000. The dispenser 2000 may use similar components to the dispenser 1000 described above. In this embodiment, there may be multiple batch tanks 400A and 400B. The parallel batch tanks 400A and 400B may be used to receive multiple brand specific beverage bases. For example, the batch tank 400A may receive a beverage base for a beverage brand A and the batch tank 400B may receive a beverage base for a beverage brand B. Each batch tank or a pair of batch tanks may be used to produce a brand specific beverage base as described above with respect to FIG. 1. Furthermore, where the brand specific beverage base requires a two-part micro-ingredient, both micro-ingredients may be metered to the specific batch tank. Likewise, where the brand specific beverage base requires a single micro-ingredient, the micro-ingredient may be metered to the specific batch tank.

The dispenser 2000 may include the source 100, vacuum regulator 105, and the metering pump 110. In addition, the sweetener from source 100 may be directed to either batch tank 400A or 400B by a three-way diverter valve 28A. A three-way diverter valve 28A may be a solenoid valve or any other type of valve. In some embodiments, the three-way diverter valve 28A may be associated with each of the micro-ingredients 200A-200N and corresponding pumps 205A-205N. Diluent inlet 20 may be metered to either batch tank 400A or 400B via a conventional mechanical flow controller 25 and via a three-way diverter valve 28C. Micro-ingredients 200A-200N may be metered to either batch tank 400A or 400B via three-way diverter valve 28B to create a brand specific beverage base within a specific batch tank.

In addition, the diluent inlet 20 may be metered to the batch tanks 400A and 400B via other means of metering the diluent. The batch tanks 400A and 400B may maintain atmospheric pressure. Furthermore, both batch tanks 400A and 400B may have a high-low sensor to detect the level of micro-ingredient. When the level of ingredient drops below the low-level sensor, the electronic controller (not shown) may simultaneously open the diluent solenoid valve 27, pulse the pumps 205A-205N at a predetermined rate, and run the pump 110 for the sweetener source 100 at a predetermined rate. Three-way diverter valves 28A, 28C, and 28B respectively located downstream from the pump 110, the mechanical flow controller 25, and the pumps 205A-205N may direct the flow of the mixed ingredient to the respective batch tanks 400A and 400B. This may allow all of the ingredients to be continuously metered to batch tank 400A and 400B in the proper ratio to form a brand specific beverage base within the specific batch tank. When the ingredient level rises above the high level sensor, the flow of all ingredients may be simultaneously stopped. Furthermore, on-demand pumps may draw micro-ingredients from the bottom of batch tanks 400A and 400B as needed for each brand specific beverage base. When in dispense mode, the brand specific beverage base from batch tanks 400A and 400B may be dispensed to the nozzles 401 and 402, respectively, via on-demand pumps 401A and 402A.

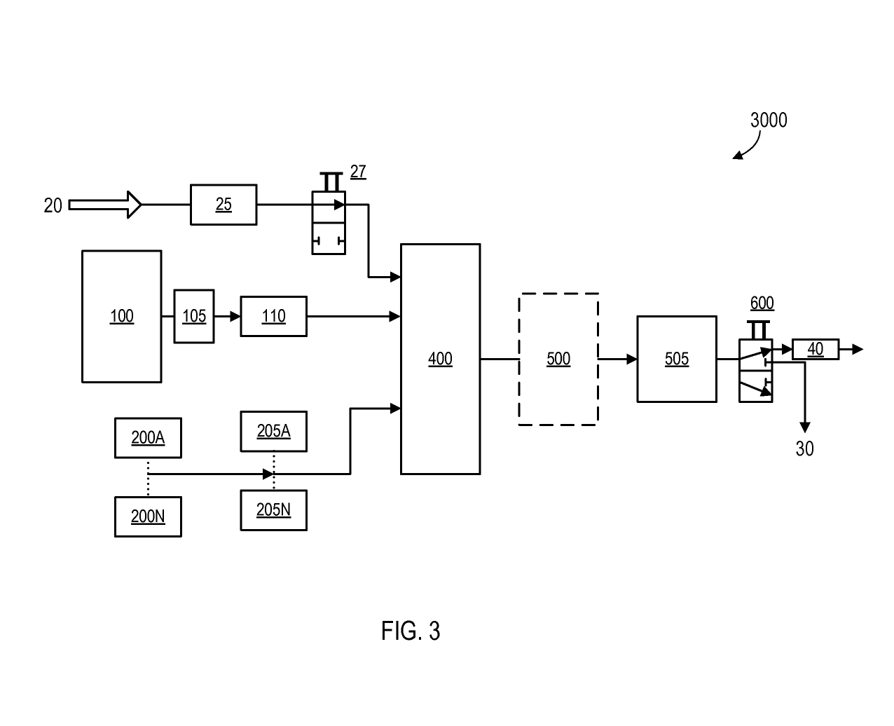

FIG. 3 shows a further embodiment of a dispenser 3000. The dispenser 3000 may include a mixing chamber 400, an optional storage tank 500 equipped with high level and low level probes, and a solenoid valve 600. Micro-ingredients 200A-200N may be in communication with a mixing chamber 400 via pumps 205A-205N respectively. Pumps 205A-205N may include conventional metered pumps, positive displacement pumps, such as reciprocating, metering, solenoid (ulka), syringe pumps, rotary pumps, and/or other types of fluid moving devices. The mixing chamber 400 also may be in communication with the diluent inlet 20 via a conventional mechanical flow controller 25 and solenoid valve 27. A plurality of or one or more of the micro-ingredients 200A-200N required to constitute a desired beverage base may be mixed with diluent within the mixing chamber 400. The mixing chamber 400 also may be in communication with the sweetener source 100 via a pump 110. The pump 110 may include a conventional metered pump, positive displacement pump, such as reciprocating, metering, solenoid (ulka), syringe pump, rotary pump, and/or other types of fluid moving device.

At the start of a dispense, the solenoid valve 27 may open permitting the diluent to flow into the mixing chamber 400 at a low flow rate but with high linear velocity. For example, the flow rate may be about one (1) milliliter per second. Other flow rates may be used herein. The pumps 205A-205N then may begin pumping the desired micro-ingredients 200A-200N. The micro-ingredients 200A-200N together with the diluent inlet 20 may flow to the mixing chamber 400 where they may be combined to produce a brand specific beverage base as described above with respect to FIG. 1.

The brand specific beverage base may be pushed to the optional storage tank 500. The optional storage rank 500 may be refrigerated for the storage of a brand specific beverage base therein and having a motor driven impeller or rotating mixing blade within the tank. A refrigerated storage tank may be used for further storage and dispensing of the brand specific beverage base and also has a rotating mixing blade therein. The optional storage rank 500 may be in communication with three-way diverter valve 600 via pump 505. The three-way diverter valve can be a solenoid valve or any other type of valve. The pump 505 may include a conventional metered pump, positive displacement pump, such as reciprocating, metering, solenoid (ulka), syringe pump, rotary pump, and/or other types of fluid moving device. The three-way diverter valve 600 may be in communication with a nozzle 40 to dispense the brand specific beverage base along with a diluent to produce a finished beverage. In some embodiments, the brand specific beverage base (along with a diluent to produce a finished beverage) may be pumped directly from the mixing chamber 400 to the nozzle 40 via the three-way diverter valve 600.

At the end of the dispense, the pumps 205A-205N and the sweetener source 100 may stop but the diluent inlet 20 may continue to flow into the mixing chamber 400.

The flow of diluent through the mixing chamber 400 may carry the mixed micro-ingredients and mixture of a sweetener displaced after the end of the dispense to the three-way diverter valve 600 via the pump 505 and the storage tank 500. The mixed micro-ingredients and mixture of a sweetener displaced after the end of the dispense may be diverted to a drain 30 by the three-way diverter valve 600 as part of a post-dispense flush cycle. The three-way diverter valve 600 may be positioned about the nozzle 40. As is shown in FIG. 3, the three-way diverter valve 600 may have a dispense mode and a flush mode. The three-way diverter valve 600 may include a drain 30 that leads to an external drain. The drain 30 may be angled so as to promote flow towards the external drain.

The three-way diverter valve 600 may stay in the flush mode until a dispense begins so as to flush any remaining residual mixed micro-ingredients and mixture of a sweetener. Once a dispense begins, the three-way diverter valve 600 may switch to the nozzle 40 where it may be mixed with a diluent to produce a finished beverage. The brand specific beverage base may have a clear path out of the 3-way diverter valve 600 and the nozzle 40. The three-way diverter valve 600 may remain in this position for a few seconds after the dispense to allow the mixing chamber 400 to drain into the storage tank 500. The three-way diverter valve 600 may then return to the flush mode. The flushing fluid then may pass through the three-way diverter valve 600 to the drain 30 so as to flush the mixing chamber 400 and the storage tank 500 and to minimize any carry over in the next brand specific beverage base.

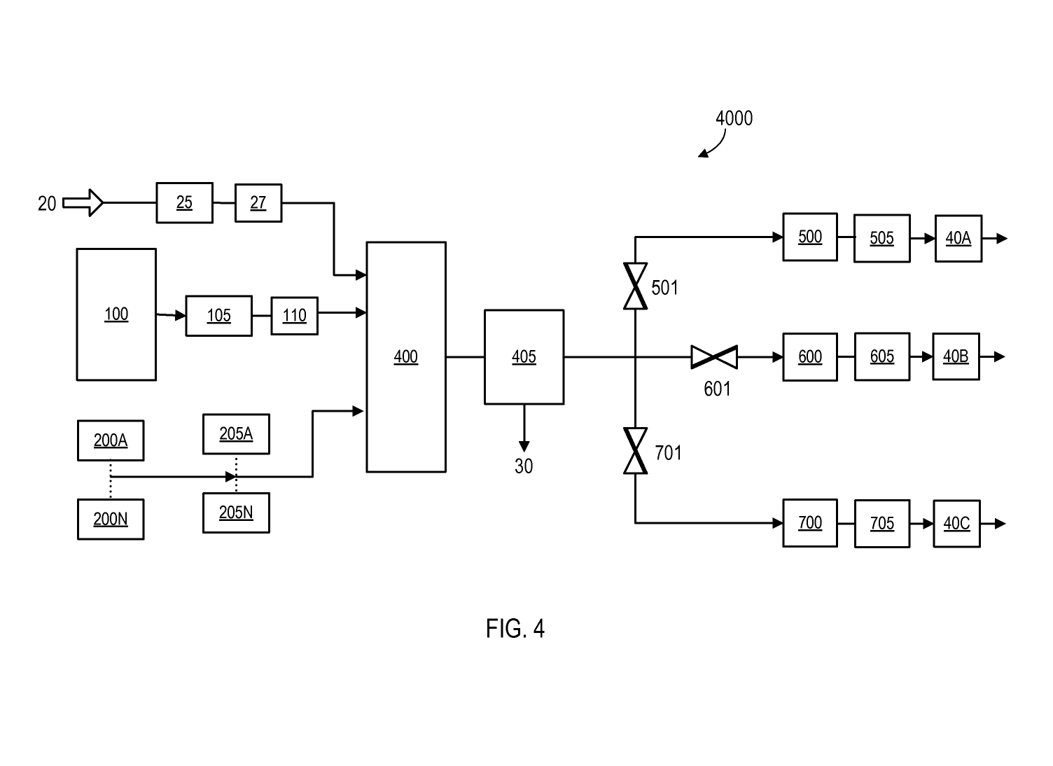

FIG. 4 shows a dispenser 4000. The dispenser 4000 may include a three-way diverter valve 405 that may be positioned downstream from of the mixing chamber 400. The three-way diverter valve 405 may be similar to the three-way diverter valve 600 described above with respect to FIG. 3. The three-way diverter valve 405 may be in communication with batch tanks 500, 600, and 700 via on-off solenoid valves 501, 601, and 701 to dispense ingredients for forming brand specific beverage bases to each of the batch tanks 500, 600, and 700, respectively. The batch tanks 500, 600, and 700 may also be in communication with pumps 505, 605, and 705, respectively. The pumps 505, 605, and 705 may be in communication with nozzles 40A, 40B, and 400, respectively.

Batch tanks 500, 600, and 700 may maintain atmospheric pressure. Furthermore, the batch tanks 500, 600, and 700 may have a high-low sensor (not shown) to detect an ingredient level of within each of the batch tanks 500, 600, and 700. When the level of an ingredient drops below the low-level sensor, an electronic controller (not shown) may simultaneously open the diluent inlet 20, pulse the pumps 205A-205N at a predetermined rate, and run the metering pump 110 for the sweetener source 100 at a predetermined rate. This may allow all of the ingredients to be metered to the respective batch tank 500, 600, or 700 in the proper ratio to form a brand specific beverage base for the respective batch tank. Examples of various brand specific beverage bases which may be formed are discussed above with respect to FIG. 1. When the ingredient level rises above the high level sensor, the flow of all ingredients may be simultaneously stopped. Furthermore, on-demand pumps may draw ingredients from the bottom of batch tanks 500, 600 and 700 as needed for each brand specific beverage base.

At the end of the dispense, the pumps 205A-205N, and the sweetener metering pump 110 may stop but the diluent inlet 20 may continue to flow into the mixing chamber 400. The flow of diluent through the mixing chamber 400 may carry the mixed micro-ingredients and mixture of a sweetener displaced after the end of the dispense to the three-way diverter valve 405. The mixed micro-ingredients and mixture of a sweetener displaced after the end of the dispense may be diverted by the three-way diverter valve 405 to a drain as part of a post-dispense flush cycle. The three-way diverter valve 405 may be positioned about the drain 30 or the on-off solenoid valves 501, 601, and 701 to batch tanks 500, 600, and 700. As is shown in FIG. 4, the three-way diverter valve 405 may have a dispense mode and a flush mode. When in dispense mode, the three-way diverter valve 405 may re-fill the desired batch tank with an additional volume of beverage base.

In the embodiments described above, highly concentrated beverage ingredients may be mixed to locally produce a beverage base for distribution in a location. In some embodiments, the highly concentrated beverage ingredients may be used with legacy dispensing systems having legacy nozzles. In other embodiments, micro-ingredients in addition to other beverage ingredients may be utilized with from modern dispensing systems and nozzles for dispensing beverages therefrom. As discussed above, in some embodiments, a common set of ingredients, mixing, and pumping equipment may be utilized to distribute a beverage base to multiple nozzles in a dispenser. In other embodiments, a common set of ingredients may be utilized to provide multiple brand specific beverage bases to different nozzle locations in a dispenser. In other embodiments, a beverage dispenser may be configured for on-demand mixing of a beverage base for immediate dispense at a nozzle. In this configuration, multiple brand specific beverage bases may be dispensed at the same legacy nozzle. In other embodiments, a common mixing chamber may be utilized for mixing multiple brand specific beverage bases in a dispenser.

What is claimed is:

1. A dispenser system, comprising:
a diluent inlet;
a blending module comprising at least one batch tank for receiving a diluent from the diluent inlet and a plurality of ingredients to form a beverage base; and
a plurality of dispensing nozzles in communication with the blending module, each of the plurality of dispensing nozzles being operable to receive the beverage base from the at least one batch tank.

2. The dispenser system of claim 1, wherein the plurality of ingredients comprises a sweetener from a sweetener source and a plurality of micro-ingredients.

3. The dispenser system of claim 2, wherein the sweetener comprises high fructose corn syrup.

4. The dispenser system of claim 2, further comprising one or more first pumps configured to pump the sweetener to the blending module.

5. The dispenser system of claim 1, further comprising one or more second pumps configured to pump the micro-ingredients to the blending module.

6. The dispenser system of claim 5, wherein the one or more second pumps comprise a metered pump or a positive displacement pump.

7. The dispenser system of claim 1, further comprising one or more metering devices configured to meter the diluent inlet to the blending module.

8. The dispenser system of claim 7, wherein the one or more metering devices comprise a metered pump, a positive displacement pump, or a mechanical flow control.

9. The dispenser system of claim 2, wherein the at least one batch tank comprises a plurality of batch tanks, each of the plurality of batch tanks being configured to receive different ingredients from the plurality of ingredients for forming different beverage bases.

10. The dispenser system of claim 9, wherein the sweetener source is in fluid communication with the plurality of batch tanks via a three-way diverter valve.

11. The dispenser system of claim 9, wherein the diluent inlet is in fluid communication with the plurality of batch tanks via a three-way diverter valve.

12. A dispenser system, comprising:
a diluent inlet;
a plurality of ingredient sources;
a plurality of batch tanks for receiving a diluent from the diluent inlet and a plurality of ingredients from the plurality of ingredient sources for forming a plurality of different beverage bases; and
a plurality of dispensing nozzles in communication with the plurality of batch tanks, each of the plurality of dispensing nozzles being operable to receive one of the plurality of different beverage bases from each of the plurality of batch tanks.

13. The dispenser system of claim 12, wherein the plurality of ingredient sources comprises a sweetener source and a plurality of micro-ingredient sources.

14. The dispenser system of claim 13, further comprising one or more first pumps configured to pump a sweetener from the sweetener source to each of the plurality of batch tanks.

15. The dispenser system of claim 13, further comprising one or more second pumps configured to pump a plurality of micro-ingredients from the plurality of micro-ingredient sources to each of the plurality of batch tanks.

16. A dispenser system, comprising:
a diluent inlet;
a plurality of ingredient sources;
a plurality of batch tanks;
a mixing chamber in fluid communication with the diluent inlet, the plurality of ingredient sources, and the plurality of batch tanks, the mixing chamber being configured to receive diluent from the diluent inlet and a plurality of ingredients from the plurality of ingredient sources;
a multiport valve in fluid communication with the mixing chamber, wherein the multiport valve is configured to dispense the diluent and the plurality of ingredients to each of the plurality of batch tanks for forming a plurality of different beverage bases; and
a plurality of nozzle assemblies associated with the plurality of batch tanks for dispensing the plurality of different beverage bases.

17. The dispenser system of claim 16, wherein the plurality of ingredient sources comprises a sweetener source and a plurality of micro-ingredient sources.

18. The dispenser system of claim 17, further comprising one or more first pumps configured to pump sweetener from the sweetener source to the mixing chamber.

19. The dispenser system of claim 18, further comprising one or more second pumps configured to pump a plurality of micro-ingredients from the plurality of micro-ingredient sources to the mixing chamber.

20. The dispenser system of claim 18, wherein each of the plurality of batch tanks is in communication with a batch tank pump, each of the batch tank pumps being in communication with one of the plurality of nozzle assemblies.
